(19) United States
(12) Patent Application Publication
(10) Pub. No.: US 2026/0241748 A1
(43) Pub. Date: Aug. 20, 2026

(54) TIRE CORD AND MANUFACTURING METHOD THEREOF

(71) Applicant: KOLON INDUSTRIES, INC., Seoul (KR)

(72) Inventors: Sung Ho PARK, Seoul (KR); Song Yeon CHOI, Seoul (KR); II CHUNG, Seoul (KR)

(21) Appl. No.: 19/160,506

(22) PCT Filed: Apr. 17, 2024
(86) PCT No.: PCT/KR2024/005110

§ 371 Date: Aug. 28, 2025

(30) Foreign Application Priority Data
Apr. 24, 2023 (KR) 10-2023-0053326

(51) Int. Cl. B60C 9/00; D01D 5/084; D01D 5/088; D02G 3/02; D02G 3/48; D07B 1/02

(52) U.S. Cl. CPC B60C 9/0042; D01D 5/084; D01D 5/088; D02G 3/02; D02G 3/48; D07B 1/02; B60C 2009/0085; D07B 2201/2009; D07B 2205/2039; D07B 2401/2055; D07B 2501/2046; D10B 2331/04; D10B 2401/063; D10B 2505/022

(57) ABSTRACT

Provided herein is a high tenacity tire cord having a tenacity of 8.0 g/d or more, a LASE@2% of 1.1 g/d or more, and a LASE@5% of 2.5 g/d or less, and a toughness of 183 g/d·mm or more according to the ASTM D 885 standard test method, and satisfying a side wall indentation (SWI) value of 3.6% or less, and a manufacturing method thereof.

### TECHNICAL FIELD

The present disclosure relates to a tire cord using a high-tenacity polyester yarn and a manufacturing method thereof.

### BACKGROUND OF ART

As the performance of automobiles gradually improves and road conditions improve, it is required to maintain the stability and durability of tires during high-speed driving of automobiles. In addition, considering environmental issues, energy issues, fuel efficiency and the like, there is a demand for tires having excellent durability while being lightweight. As one way to meet these needs, tire cords, used as rubber reinforcing materials in tires, are being actively studied.

The tire cord is manufactured using an industrial yarn, for example, a polyester yarn. In addition, in order to improve the physical properties of the tire cords, studies have been continuously conducted to improve the mechanical properties of the polyester yarn, for example, tensile strength, elongation, and the like.

Polyester yarn, which is a kind of industrial yarn, can be generally produced by melting a polyester chip, discharging the molten polyester using a spinneret to form a filament, cooling the semi-solidified filament discharged from the spinneret, and bundling, stretching and winding the cooled filaments.

At this time, in order to reduce the weight of tires, research is being conducted on methods for reducing the fineness of polyester tire cords (e.g., a PET tire cord). In order to achieve the weight reduction of the tire, three physical properties of modulus, toughness and shrinkage must be satisfied, but a method that satisfies all of the required physical properties of the tire cord has not yet been developed. That is, when the fineness of the tire cord is lowered, the pressure in the spinning pack and the spinneret is reduced, and thus the toughness of the tire cord is reduced, so that all desired physical properties cannot be realized.

### DETAILED DESCRIPTION OF THE INVENTION

### Technical Problem

It is an object of the present disclosure to provide a tire cord that satisfies all of the high strength, high modulus, low shrinkage and high elongation at break characteristics for tire cords that use polyester having a wide range of fineness, and can realize tire weight reduction.

It is another object of the present disclosure to provide a method for manufacturing the tire cord.

### Technical Solution

According to the present disclosure, there may be provided a tire cord, comprising a polyester yarn including 90 mol % or more of polyethylene terephthalate, and having a tenacity of 8.0 g/d or more, a LASE@2% of 1.1 g/d or more, and a LASE@5% of 2.5 g/d or less, and a toughness of 183 g/d·mm or more according to the ASTM D 885 standard test method, and satisfying a side wall indentation (SWI) value of 3.6% or less.

In the physical properties of the tire cord, the side wall indentation may be measured by the following Equation 1:

$$SWI ( \% ) = [ ( D ) - ( C ) ] + [ ( A ) - ( B ) ] \qquad [ Equation 1 ]$$

in Equation 1,
(A) is a dry heat shrinkage, measured after measuring the dry heat shrinkage using a shrinkage tester (measuring with a specimen length of 250 mm, 180° C., 2 minutes, under a load of an initial tension of 20 to 45 g), and then air-cooling it for 1 min,
(B) is a dry heat shrinkage, measured after measuring the dry heat shrinkage using a shrinkage tester (measuring with a specimen length of 250 mm, 180° C., 2 minutes, under a load of an initial tension of 40 to 90 g), and then air-cooling it for 1
(C) is an intermediate elongation of the (A) specimen according to the ASTM D 885 standard test method measured at a load of 1.5 to 3.0 kg, and
(D) is an intermediate elongation of the (B) specimen according to the ASTM D 885 standard test method measured at a load of 3.0 to 6.0 kg.

The (A) may be 1.0 to 3.2%, the (B) may be 0.7 to 2.8%, the (C) may be 1.3 to 1.7%, and the (D) may be 4.2 to 4.6%.

Further, the tire cord may have a strength ratio (strength utilization ratio) of 88% or more according to the following Equation 2.

$$[ Equation 2 ]$$

$$Strength ratio ( \% ) = [ Tensile strength of tire cord ( g / d ) / Tensile strength of polyester yarn ( g / d ) ] \times 100$$

The tire cord may include a high-tenacity polyester yarn made from polyester multifilaments including 200 to 2,000 polyester monofilaments having a fineness of 2.5 to 3.5 denier; and an adhesive layer impregnated with a high-tenacity polyester yarn.

The polyester yarn may be prepared from a molten polyester resin comprising 90 mol % or more of polyethylene terephthalate and having an intrinsic viscosity of 1.0 dl/g or more.

The polyester yarn may have a tensile strength of 7.5 to 11.0 g/d and an elongation of 10 to 20%.

The tire cord may include a raw-cord having a total fineness of 1000 to 6000 denier.

Further, according to the present disclosure, there may be provided a method for manufacturing a tire cord, comprising the steps of: spinning a molten polyester resin comprising 90 mol % or more of polyethylene terephthalate and having an intrinsic viscosity of 1.0 dl/g or more using a spinning pack including a spinneret having a nozzle unit to produce a polyester yarn; producing a ply-twisted yarn using the polyester yarn; and immersing the ply-twisted yarn in an adhesive solution and heat-treating the yarn.

More specifically, the step of producing the polyester yarn may comprise a step of discharging the molten polyester resin through a spinneret including a nozzle unit having a shear rate of 220 to 260 1/sec and a polymer discharge rate of 2.0 m/min or less under the pressure condition of the spinning pack of 1800~2500 psi to form a polyester multifilament including a polyester monofilament having a fineness of 2.5 to 3.5 denier.

The tire cord provided in accordance with the method for manufacturing a tire cord may have a tenacity of 8.0 g/d or more, a LASE@2% of 1.1 g/d or more, and a LASE@5% of 2.5 g/d or less, and a toughness of 183 g/d·mm or more according to the ASTM D 885 standard test method, and satisfy a side wall indentation (SWI) value of 3.6% or less.

The polyester multifilament may comprise 200 to 2,000 polyester monofilaments having a fineness of 2.5 to 3.5 denier.

Further, the step of producing a polyester yarn may comprise a step of discharging the molten polyester resin with an intrinsic viscosity of 1.0 dl/g or more through a spinneret including a nozzle unit having a shear rate of 220 to 260 1/see and a polymer discharge rate of 2.0 m/min or less under the pressure condition of the spinning pack of 1800~2500 psi to produce a plurality of filaments; a step of heating the plurality of discharged filaments through a heating unit; a step of cooling the plurality of heated filaments through a cooling unit; a step of bundling the plurality of filaments to form a polyester multifilament; a step of drawing the polyester multifilament; and a step of winding the drawn multifilament.

The step of drawing the polyester multifilament may comprise a step of drawing the polyester multifilament in a total draw ratio of 1.0 to 3.0 times.

### Advantageous Effects

According to the present disclosure, while applying a low DPF (denier per filament) during the production of polyester yarn, the polymer discharge speed at the nozzle can be adjusted to impart high spinning tension and spinning draft, and at the same time, the discharge pressure from the spinning pack can be set high to maintain a high shear rate at the nozzle, whereby the excellent mechanical properties of the polyester yarn in the tire cord are maintained and all properties required for weight reduction can be satisfied.

Therefore, according to the present disclosure, a lightweight tire cord that satisfies all of high tenacity, high modulus, low shrinkage and high elongation at break can be provided.

### BRIEF DESCRIPTION OF THE DRAWINGS

FIG. 1 is a schematic diagram of a yarn manufacturing apparatus according to an embodiment of the present disclosure.

### DETAILED DESCRIPTION OF THE EMBODIMENTS

Hereinafter, a tire cord and a manufacturing method thereof according to the embodiments of the present disclosure will be described in more detail.

Unless defined otherwise herein, all technical and scientific terms have the same meaning as commonly understood by a person skilled in the art to which the invention pertains. The terms used in this disclosure are merely to effectively describe specific embodiments and are not intended to limit the present disclosure.

Singular forms used in this specification include plural forms as well, unless the context clearly dictates otherwise.

As used herein, the term “comprise” specifies particular features, regions, integers, steps, operations, elements, and/or components, and does not exclude the presence or addition of other specific features, regions, integers, steps, operations, elements, components, and/or groups.

As the present invention can be variously modified and take various forms, specific embodiments are exemplified and described in detail below. However, it is not intended to limit the present disclosure to the specific disclosed forms, and it should be understood to include all modifications, equivalents, and replacements that fall within the spirit and technical scope of the invention.

In this specification, when the position relation between two parts is described using the terms such as “on”, “above”, “below”, and “next”, one or more parts may be positioned between the two parts unless the terms are used with the term “immediately” or “directly”.

In this specification, for example, when the temporal precedence relationship is described using terms such as “after~”, “subsequently~”, “next~”, or “before~”, it may also include non-consecutive cases unless the terms “immediately” or “directly” are used.

In this specification, the term “primarily twisted yarn” means a single yarn produced by twisting a single filament in any one direction.

In this specification, the term “plied yarn” means a yarn made by twisting two or more single yarns together in any one direction, and it is also referred to as “raw cord”.

In this specification, the term ‘tire cord’ means the plied yarn including an adhesive so that it can be directly applied to rubber products for tires, and is also referred to as ‘dip-cord’.

According to one embodiment of the present disclosure, there may be provided a tire cord, comprising a polyester yarn including 90 mol % or more of polyethylene terephthalate, and having a tenacity of 8.0 g/d or more, a LASE@2% of 1.1 g/d or more, and a LASE@5% of 2.5 g/d or less, and a toughness of 183 g/d·mm or more according to the ASTM D 885 standard test method, and satisfying a side wall indentation (SWI) value of 3.6% or less.

The present inventors have designed a method for excellently maintaining mechanical physical properties such as tensile strength and elongation of polyester yarn, by including a polyester yarn that is manufactured by applying a high multifilament spinning method, which satisfies the spinning conditions of low denier per filaments, low nozzle ejection rate, and low shear rate, and by adjusting the pressure of the spinning pack, and confirmed through experiments that by including the polyester yarn in accordance with the above method, a high-tenacity tire cord capable of exhibiting all of the physical properties of high modulus, high toughness, and stable shrinkage rate can be provided, thereby completing the invention.

At this time, the term DPF (denier per filaments) as used herein means a denier value per polyester monofilament included in the polyester yarn.

A tire cord is manufactured through a three-step process consisting of yarn production, a twisting process using the yarn, and a heat treatment, and it is necessary to maintain the above yarn physical properties in the tire cord in order to obtain a product with excellent performance.

That is, the yarn goes through a post-process called twisting and heat treatment, and at this time, the physical properties of the yarn are deteriorated and changed. For example, a decrease in strength and toughness may occur, and shrinkage and intermediate elongation can also be changed. Therefore, it is necessary to maintain the physical properties of the yarn even through the post-process.

In addition, the physical properties required for tire cords for tire weight reduction must satisfy all of three physical properties as a tire cord: high modulus, high toughness, and low and stable shrinkage in order to replace the existing fineness range.

At this time, the factor indicating the modulus is LASE (Load At Specific Elongation), the factor indicating the shrinkage is side wall indentation (SWI).

Further, it is necessary to adjust the modulus to be low over a certain interval for high toughness. That is, even if the modulus is increased, it is necessary to prevent deterioration of other physical properties such as toughness. For example, control of LASE@5% is required, which is the size of the modulus determined by the load (g/d) at the elongation corresponding to 5% in the tensile load curve obtained by the ASTM D885 measurement method.

However, conventionally, a tire cord satisfying all of three physical property factors has not been developed, whereas the tire cord according to the present embodiment exhibits high tenacity even after post-processing of the yarn, and satisfies all of excellent modulus, toughness, and shrinkage properties.

Such a tire cord can be provided by including a polyester yarn produced by adjusting the pressure of the spinning pack together with a high multi filament spinning method.

Specifically, the yarn production conditions use the high multifilament spinning method, which means applying low denier per filaments (DPF), low nozzle ejection rates at nozzles, and low shear rates at nozzles.

However, such manufacturing conditions may result in a decrease in pressure in the spinning pack/spinneret, which is associated with a decrease in the toughness of the tire cord.

That is, the high multifilament spinning method can express the physical properties of high strength, high modulus, and stable shrinkage of the tire cord, but is associated with a decrease in toughness (elongation at break). This is because each property has a conflicting relationship, and therefore, if spinning is performed by a conventional general method, it is impossible to realize the physical properties of a tire cord that satisfies all of the desired physical properties.

Therefore, in the present specification, while applying a high multi-filament spinning method with specific spinning conditions, the invention was devised to maintain high toughness by simultaneously adjusting the pressure of the spinning pack.

In addition, the toughness limits the modulus range at LASE@5% to a specific range.

As the tire cord manufactured by the above method satisfies all of the above-mentioned high strength, high modulus, low shrinkage and high elongation while maintaining excellent physical properties of the yarn, and thus, can be used in a tire that realizes weight reduction of the tire and improves rolling resistance.

That is, it is possible to improve the rolling resistance by realizing the gauge down of the fineness of the tire cord (from 2000De to 1500De, from 3000De to 2000De).

Further, according to the embodiment, it is possible to improve the physical properties of the tire, which deteriorates as the fineness of the tire cord is decreased.

More specifically, the tire cord of the present embodiment may have a tenacity more according to the ASTM D 885 standard test method of 8.0 g/d or more, or 8.5 g/d or more, and may also have a tenacity of 11 g/d or less, or 10 g/d or less.

Further, the tire cord of the embodiment may have a LASE@2% value of 1.1 g/d or more, or 1.15 g/d or more, or 1.20 g/d or more according to the ASTM D 885 standard test method indicating the modulus. In addition, the LASE@2% value may be 1.5 g/d or less, or 1.45 g/d or less, or 1.4 g/d or less.

The tire cord may have a LASE@5% value of 2.5 g/d or less, or 2.45 g/d or less, or 2.4 g/d or less according to the ASTM D 885 standard test method. Further, the LASE@5% value may be 2.0 g/d or more, or 2.05 g/d or more, or 2.1 g/d or more.

The tire cord may have a toughness of 183 g/d·mm or more, or 200 g/d·mm or more, or 210 g/d·mm or more according to the ASTM D 885 standard test method. Further, the tire cord may have a toughness of 300 g/d·mm or less, or 280 g/d·mm or less, or 250 g/d·mm or less according to the ASTM D 885 standard test method.

The tire cord may have a side wall indentation (SWI) value of 3.6% or less, or 3.55% or less, or 3.4% or less, and may have a side wall indentation (SWI) value of 3.0% or more, or 3.1% or more, or 3.2% or more, or 3.3% or more.

Further, the tire cord may have a toughness of 300 g/d·mm or less, or 280 g/d·mm or less, or 250 g/d·mm or less according to the ASTM D 885 standard test method.

Therefore, the tire cord according to one embodiment may have a tenacity of 8.0 to 11 g/d, a LASE@2% of 1.1 to 1.5 g/d, and a LASE@5% of 2.5 to 2.5 g/d, and a toughness of 183 to 300 g/d·mm according to the ASTM D 885 standard test method, and satisfying a side wall indentation (SWI) value of 3.0 to 3.6%.

At this time, in the physical properties of the tire cord, the side wall indentation may be measured by the following Equation 1:

$$SWI ( \% ) = [ ( D ) - ( C ) ] + [ ( A ) - ( B ) ] \qquad [ Equation 1 ]$$

in Equation 1,
(A) is a dry heat shrinkage, measured after measuring the dry heat shrinkage using a shrinkage tester (measuring with a specimen length of 250 mm, 180° C., 2 minutes, under a load of an initial tension of 20 to 45 g), and then air-cooling it for 1 min,
(B) is a dry heat shrinkage, measured after measuring the dry heat shrinkage using a shrinkage tester (measuring with a specimen length of 250 mm, 180° C., 2 minutes, under a load of an initial tension of 40 to 90 g), and then air-cooling it for 1
(C) is an intermediate elongation of the (A) specimen according to the ASTM D 885 standard test method measured at a load of 1.5 to 3.0 kg, and
(D) is an intermediate elongation of the (B) specimen according to the ASTM D 885 standard test method measured at a load of 3.0 to 6.0 kg.

Further, the (A) may be 1.0 to 3.2%, the (B) may be 0.7 to 2.8%, the (C) may be 1.3 to 1.7%, and the (D) may be 4.2 to 4.6%.

In the present specification, the dry heat shrinkage ratio before cooling of the (A) and (B) may be a ratio in which the ratio between the length (L₀) measured under an initial tension load selected from the range after a tire cord having a specimen length of 250 mm was left at 25° C. and 65% RH for 24 hours, and the length (L₁) after treatment at 180° C. for 2 minutes under the initial tension load, was measured using a shrinkage tester. That is, the length change rate {=[(L₀−L₁)/L₀]×100} of the specimen may be defined as the dry heat shrinkage rate (L₂). L₀ and L₁ may each be measured five times.

In addition, the dry heat shrinkage after cooling down may mean the length change rate of L₂ and L₃ ({=[(L₂−L₃)/L₂]×100}) after measuring the length (L₃) of the specimen that has been left to cool down for 1 minute after the measurement of L₂. The cooling down can be performed at room temperature.

Further, the initial tension loads of the (A) and (B) and the loads of the (C) and (D) can be measured by appropriately setting the load range within the above range according to the fineness of the tire cord without fineness distinction.

That is, the SWI is not limited to the fineness range of the tire cord, and can be measured by adjusting the load range appropriately according to various fineness range conditions and determining the average value. Specifically, the SWI may be defined and set as each load according to the fineness of the tire cord.

According to an embodiment of the present disclosure, the fineness of the tire cord may include a raw-cord having a total fineness of 1000 to 6000 denier. Additionally, the initial tension range may be set according to the total fineness of the raw-cords included in the tire cord, which is set according to the manufacturing conditions of the yarn.

Therefore, according to the embodiment of the present disclosure, when the total fineness of the tire cord is set in the range of 3000 denier and 4000 denier, the super-tensile load of the (A) may be 35 to 45 g, the super-tensile load of the (B) may be 70 to 90 g, the load of the (C) may be 2.3 to 3.0 kg, and the load of the (D) may be 4.6 to 6.0 kg.

More specifically, when the fineness of the tire cord is set to 2000 denier, 2600 denier, 3000 denier, and 4000 denier, the initial tension load for measuring the dry heat shrinkage of the (A) may be 20 g, 30 g, 35 g, and 45 g, respectively.

The super-tensile load for measuring the dry heat shrinkage of (B) under each denier condition may be 40 g, 60 g, 70 g, and 90 g, respectively.

Further, the load of the (C) under each denier condition may be 1.5 kg, 2.0 kg, 2.3 kg, 3.0 kg.

Further, the load of the (D) under each denier condition may be 3.0 kg, 4.0 kg, 4.6 kg, 6.0 kg.

Further, the dry heat shrinkage rate may be an average value of the values measured at least 3 times, 4 times, or 5 times or more under the load range.

The tire cord may have a strip strength of 0.94 kg/dm/denier or more measured.

Specifically, the reinforcing ability in a certain area of a tire is important in terms of tire performance. In addition, in order to reduce the weight of a tire, the strip strength according to the fineness is important, and when this performance is high, the reinforcing ability of the tire is excellent.

Therefore, high-strength cords should be used for excellent tire reinforcing ability and density should be increased by optimizing the distance between cords.

Thus, the tire cord of the present disclosure exhibits a high strip strength value of 0.94 kg/dm/denier or more, thereby improving tire performance.

More specifically, the strength of the strip may be defined as strength in a certain area and may mean performance of a fabric in a tire in the present disclosure.

The strip strength can be obtained by measuring the strength (kg/dm) per 1 decimeter (10 cm). In addition, the strength of the strip may be expressed as a strength when the tenacity is converted into a value per denier (kg/dm/denier).

In addition, in the present disclosure, the fabric may be a ply-twisted yarn (i.e., low cord) using polyester yarns immersed in an adhesive solution and heat-treated (i.e., dip cord).

According to one embodiment of the preferred present disclosure, the strip strength of the tire cord may be greater than or equal to 0.94 kg/dm/denier calculated by considering the tenacity and the density of the denier of the fabric included in the cord.

The tire cord may have a tensile strength of 7.5 to 9.5 g/d and an elongation of 14 to 22% according to the ASTM D 885 standard test method.

Further, the tire cord may have a strength ratio (strength utilization ratio) of 88% or more according to the following Equation 2.

$$[ Equation 2 ]$$

$$Strength ratio ( \% ) = [ Tensile strength of tire cord ( g / d ) / Tensile strength of polyester yarn ( g / d ) ] \times 100$$

Specifically, the tire cord may exhibit a strength utilization ratio of 88.5% or more, or 88.6% or more, or 88.7% or more, or 88.8% or more, or 88.9% or more; and, 91.0% or less, or 90.8% or less, or 90.6% or less, or 90.4% or less. Thus, the tire cord according to the present disclosure can have excellent strength.

Preferably, the tire cord may exhibit a strength utilization ratio of 88.5% to 91.0%, or 88.5% to 90.8%, or 88.6% to 90.8%, or 88.6% to 90.6%, or 88.7% to 90.6%, or 88.7% to 90.4%, or 88.8% to 90.4%, or 88.9% to 90.4%.

More specifically, the strength utilization ratio of the tire cord may be at least 90% relative to the strength of the yarn.

The tire cord may include a high-tenacity polyester yarn made from polyester multifilament including 200 to 2,000 polyester monofilaments having a fineness of 2.5 to 3.5 denier; and an adhesive layer impregnated with the high-tenacity polyester raw yarn.

Specifically, the polyester yarn including the polyester multifilament may have a single filament fineness of 2.5 to 3.5 denier and a total fineness of 500 to 3000 denier, or 1000 to 2000 denier.

The adhesive layer may be included in an amount of 0.5 to 10 parts by weight, or 1 to 8 parts by weight, or 1.5 to 6 parts by weight, based on 100 parts by weight of the high-tenacity polyester yarn.

In addition, the polyester yarn can be made from a molten polyester resin comprising 90 mol % or more of polyethylene terephthalate and having an intrinsic viscosity of 1.0 dl/g or more.

According to one embodiment of the invention, the polyester yarn may be manufactured to a polyethylene terephthalate drawn yarn (fiber) through a spinning process using a chip composed of 90 mol % or more of polyethylene terephthalate (hereinafter, PET).

Specifically, the PET drawn yarn is prepared by melt-spinning a PET resin so as to prepare an undrawn fiber, and drawing the undrawn fiber. In addition, the PET tire cord of a dip cord type may be prepared by a ply-twisting the PET drawn yarn and dipping the same into an adhesive solution.

In addition, the PET drawn yarn according to one embodiment of the present disclosure includes 90 mol % or more of PET in order to show the properties of PET suitable for the tire cord. If the PET drawn yarn includes PET in an amount less than 90 mol %, it is difficult for the PET drawn yarn and the tire cord manufactured therefrom to exhibit desirable physical properties. Therefore, the term “PET” means what includes 90 mol % or more of PET resin or polymer unless otherwise explained in the present disclosure.

The polyester yarn may have a tensile strength of 7.5 to 11.0 g/d and an elongation of 10 to 20%.

The tire cord comprises a raw cord made by twisting together two or more strands of the polyester drawn yarn in any one direction, and an adhesive attached to the raw cord.

The polyester drawn yarn may have a single fiber fineness of 2.5 to 3.5 denier and a total fineness of 500 denier to 3000 denier.

The tire cord may include a raw-cord having a total fineness of 1000 to 6000 denier.

Preferably, the tire cord may include the raw-cord having a total fineness of 1000 denier to 6000 denier, or 1000 denier to 5000 denier.

In addition, the tire cord may be a 2-ply yarn comprising the polyester drawn yarn. As a non-limiting example, the raw-cord may have a total denier of 1000 to 6000 by 2-plying the polyester drawn yarn, which has a single-filament fineness of 2.5 to 3.5 denier and a total denier of 500 to 3000.

Specifically, in one illustrative embodiment, the raw-cord can be manufactured by putting the polyester drawn yarn into a cable cord twister, and primarily and secondarily twisting the yarn at a twist number of 200 TPM to 500 TPM. A tire cord (dip-cord) can be manufactured by immersing the raw-cord in an adhesive coating solution, followed by drying and heat treatment.

Meanwhile, according to another embodiment of the disclosure, there can be provided a method for manufacturing a tire cord, comprising the steps of: spinning a molten polyester resin comprising 90 mol % or more of polyethylene terephthalate and having an intrinsic viscosity of 1.0 dl/g or more using a spinning pack including a spinneret having a nozzle unit to produce a polyester yarn; producing a ply-twisted yarn using the polyester yarn; and immersing the ply-twisted yarn in an adhesive solution and heat-treating the yarn, wherein the step of producing the polyester yarn comprises a step of discharging the molten polyester resin through a spinneret including a nozzle unit having a shear rate of 220 to 260 1/sec and a polymer discharge rate of 2.0 m/min or less under the pressure condition of the spinning pack of 1800~2500 psi to form a polyester multifilament including a polyester monofilament having a fineness of 2.5 to 3.5 denier.

Specifically, in order to manufacture a tire cord that satisfies all of the above high tenacity, high modulus, low shrinkage and high elongation, it is desirable to apply a low DPF to the polyester yarn. However, in the present disclosure, the polymer discharge speed from the nozzle as well as the low DPF for the polyester can be adjusted to impart high spinning tension and high spinning draft.

Further, under the yarn production conditions, the toughness of the yarn and the tire cord can be reduced due to the low nozzle discharge pressure. Therefore, the present disclosure has the feature that the discharge pressure in the spinning pack is set high so that the shear rate at the nozzle can be maintained high.

Therefore, the present disclosure has the feature that by adjusting the spinning conditions and at the same time, maintaining the spinning pack pressure in a certain range, the physical properties of the polyester yarn are maintained excellently in the tire cord even after the yarn goes through the post-treatment of twisting and heat treatment, thereby satisfying all of the physical properties of the tire cord required for weight reduction.

At this time, the tire cord can be manufactured by a conventional method, except for adjusting the spinning method and the pressure condition of the spinning pack when manufacturing the polyester yarn.

More specifically, as described above, the high-tenacity polyester yarn for a tire cord can be produced by spinning a molten polyester resin having an intrinsic viscosity of 1.0 dl/g or more using a spinning pack including a spinneret having a nozzle unit.

In one illustrative embodiment, the molten polyester resin may include a molten polyethylene terephthalate resin comprising a polyester yarn including 90 mol % or more of polyethylene terephthalate and having an intrinsic viscosity of 1.0 dl/g or more, or 1.1 dl/g to 1.9 dl/g. Preferably, the molten polyethylene terephthalate resin may have an intrinsic viscosity of 1.0 dl/g or more, or 1.1 dl/g or more. Further, the molten polyethylene terephthalate resin may have an intrinsic viscosity of 1.7 dl/g or less, or 1.6 dl/g or less, or 1.5 dl/g or less, or 1.4 dl/g or less.

In addition, the molten PET resin may include 90 mol % or more, 92 mol % or more, 95 mol % or more, 99 mol % or more, or 100 mol % of PET as a main component.

Further, various well-known additives may be added in the step of preparing the PET polymer constituting the undrawn yarn. Therefore, the type of additive is not limited.

In addition, the spinning can be carried out in a spinneret having a spinneret hole number of 300 to 550 at 270 to 300° C. or 275 to 300° C., or 275 to 290° C.

Further, the step of producing the polyester yarn may include, after the step of producing the plurality of filaments, a step of heating and cooling the plurality of discharged filaments, bundling the cooled filaments, and then drawing the filaments to produce a polyester drawn yarn, and then winding the same.

Preferably, the method for producing a polyester yarn may comprise a step of discharging the molten polyester resin with an intrinsic viscosity of 1.0 dl/g or more through a spinneret including a nozzle unit having a shear rate of 220 to 260 1/sec and a polymer discharge rate of 2.0 m/min or less under the pressure condition of the spinning pack of 1800~2500 psi to produce a plurality of filaments; a step of heating the plurality of discharged filaments through a heating unit; a step of cooling the plurality of heated filaments through a cooling unit; a step of bundling the plurality of filaments to form a polyester multifilament; a step of drawing the polyester multifilament; and a step of winding the drawn multifilament.

For example, the high-tenacity polyester yarn can be produced by a method comprising: a step in which the polyethylene terephthalate resin (e.g., PET chip) comprising 90 mol % or more of polyethylene terephthalate and having an intrinsic viscosity of 1.0 dl/g or more, or 1.1 dl/g or more, or 1.5 dl/g or more is melted and discharged into a plurality of filaments through a nozzle unit by adjusting the spinning conditions and the spinning pack pressure under the conditions within the ranges described above; a step of heating the plurality of discharged filaments through a heating unit positioned around the nozzle unit; a step of cooling the plurality of heated filaments through a cooling unit; a step of bundling the plurality of filaments to form a polyester multifilament; a step of drawing the polyester multifilament; and a step of winding the drawn multifilament.

At this time, the spinning pack may adjust the discharge pressure range to 1800~2500 psi (about 126.55~175.8 kgf/cm2). However, if the discharge pressure of the spinning pack is 1800 psi or less, the polymer discharge speed at a nozzle may decrease, so that the required performance cannot be achieved, and if the discharge pressure is 2500 psi or more, equipment problems such as pack leakage may occur due to excessive pressure.

Further, when discharging the molten polyester resin through the nozzle including the nozzle unit, the shear rate at nozzle may be 220 to 260 1/sec. If the shear rate is 220 1/sec or less, the orientation of the polymer in the nozzle may decrease, which may reduce the toughness of the yarn, and if the shear rate is 260 1/sec or more, a reduction in yarn draft can affect the dimensional stability of the yarn.

Further, the polymer discharge speed at the nozzle can be adjusted to be 2.0 m/min or less together with the shear rate adjustment at the nozzle. More specifically, the polymer discharge speed at the nozzle may be 0.1 to 2.0 m/min, or 0.5 to 2.0 m/min, or 1 to 2.0 m/min, or 1 to 1.9 m/min, or 1.3 to 1.9 m/min, or 1.5 to 1.9 m/min. If the polymer discharge speed is 2 m/min or more, the polymer discharge speed at the nozzle may decrease so that the required performance cannot be achieved.

Through this process, a polyester multifilament including a polyester monofilament having a fineness of 2.5 to 3.5 denier may be formed. That is, according to the present disclosure, it is meant to form a polyester multifilament including a polyester monofilament of DPF 2.5 to 3.5 De/ea.

Further, the polyester multifilament may include 200 to 2,000 polyester monofilaments having a fineness of 2.5 to 3.5 denier, or 400 to 1,200 pieces. More specifically, the fineness of the polyester monofilament may be 2.6 to 3.5 denier, or 2.7 to 3.4 denier.

The polyester yarn comprising the polyester multifilament may have a total denier of 500 to 3000, or 1000 to 2000.

Meanwhile, in the method for producing the polyester yarn, a method of heating and cooling a plurality of discharged filaments, bundling the cooled filaments, and then drawing the filaments to produce a polyester drawn yarn, and then winding the yarn can be performed in a conventional manner.

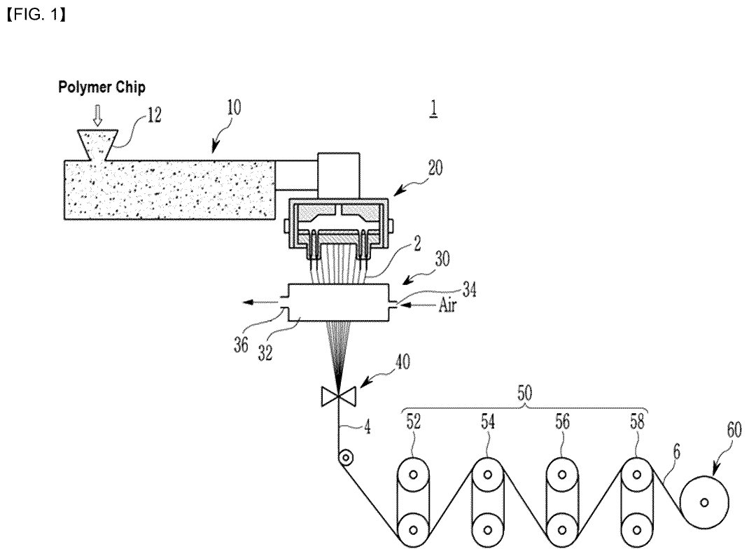

Further, as shown in FIG. 1, the polyester yarn production apparatus 1 according to the embodiment of the present disclosure includes an extruder 10, a spinning pack 20, a cooling unit 30, a bundling unit 40, a drawing unit 50, and a winder 60.

A hopper 12 may be formed on the upper surface of the extruder 10 to receive supply of polymer chips, and a heating device and a transport device are provided inside the extruder 10 to melt the polymer chips supplied through the hopper 12, and transport the molten resin to the spinning pack 20. As the polymer, a polyester resin may be used, without being limited thereto.

In the following, for convenience of description, a yarn production apparatus 1 capable of producing a polyester yarn using a polyester resin will be described as an example. However, the yarn production apparatus 1 according to the embodiment of the present disclosure is not used only for the production of polyester yarn, and can also be used for the production of other yarns known in the art.

Further, the spinning pack 20 discharges the molten polyester resin transferred from the extruder 10 to form a plurality of filaments 2. The spinning pack 20 may include a spinning block, a pack body, a spinneret, and a heating unit, and its shape is not limited thereto.

More specifically, the apparatus for producing the polyester yarn may include a spinning pack including a spinneret including a nozzle unit having a plurality of discharge holes for discharging the molten resin; a heating unit positioned around the nozzle unit to heat a plurality of filaments discharged through a plurality of discharge holes; a cooling unit for cooling the plurality of filaments heated by the heating unit; a bundling unit for bundling a plurality of filaments cooled by the cooling unit to form a multifilament; and a drawing unit for drawing the multifilament. The plurality of discharge holes may be arranged in a circle in at least two or more rows. A distance between adjacent discharge holes in any one row, a distance between adjacent discharge holes on any other row, and a distance between any one row, and discharge holes located close to each other on any other row adjacent to said any one row.

In the present disclosure, a general filament cooling method may be used for the cooling unit 30, and the method is not limited.

For example, as shown in FIG. 1, in the present disclosure, a refrigerant is flowed into the cooling chamber 32 through the refrigerant inlet 34 and can flow out the cooling chamber 32 through the refrigerant outlet 36.

Further, the high-tenacity polyester yarn for the tire cord may be produced by a method comprising a step of drawing the undrawn multifilament 4 in at least two stages, by including three or more godet rollers 52, 54, 56, and 58. At this time, the at least three godet rollers include first, second, and third godet rollers sequentially arranged based on the moving direction of the multifilament, the rotation speed of the first godet roller may be 2000 to 4000 m/min, and the rotation speed of the third godet roller may be 5000 to 7000 m/min.

The step of drawing the polyester multifilament may include a step of drawing the polyester multifilament at a total draw ratio of 1.0 times to 3.0 times, and a polyester drawn yarn can be produced through the above method.

Preferably, the total draw ratio may be 1.5 times to 3.0 times, or 1.5 times to 2.5 times. That is, in order to increase the degree of orientation through drawing and thus exhibit an appropriate level of strength, the total draw ratio of the polyester drawn yarn is preferably 1.0 times or more. However, in order to prevent yarn breakage due to excessive drawing, the total draw ratio of the polyester drawn yarn is preferably 3.0 times or less.

Further, the multi-stage drawing speed ratio can be defined as the ratio of the difference between the rotation speed of the first godet roller and the rotation speed of the second godet roller, and the difference between the rotation speed of the second godet roller and the rotation speed of the third godet roller, wherein the multi-stage drawing speed ratio may be 30:70 to 60:40.

At this time, the spinning draft may be 1500 to 2000.

In the winder 60, the polyester yarn 6 is produced by winding the multifilament stretched through the stretching unit 50.

The high-tenacity polyester yarn produced according to the above method may have a tensile strength of 7.5 to 11.0 g/d and an elongation of 10 to 20%.

Meanwhile, the step of producing a ply-twisted yarn using the polyester yarn may be a step of primarily and secondarily twisting the drawn polyester yarn under certain twist conditions to produce a raw-cord.

Specifically, in one illustrative embodiment, the raw-cord may be produced by putting the polyester drawn yarn into a cable cord twisting machine, and primarily and secondarily twisting the yarn at a twist number of 200 TPM to 500 TPM.

Further, the step of immersing the ply-twisted yarn in an adhesive solution and heat-treating the yarn may be a step of immersing the raw-cord in an adhesive solution, followed by drying and heat treatment to produce a tire cord (dip-cord).

Specifically, the adhesive layer may be formed by impregnating the ply-twisted yarn in a commonly known adhesive solution, but as the adhesive solution, a conventional tire cord, for example, resorcinol-formaldehyde-latex (RFL) adhesive solution can be used.

After impregnating the adhesive solution, a heat treatment step may be performed. The heat treatment step may be carried out at a temperature of 220 to 260° C. for 90 to 360 seconds, preferably at a temperature of 230 to 250° C. for 90 to 240 seconds, and more preferably at a temperature of 240 to 245° C. for 90 to 120 seconds.

By immersing the high-tenacity polyester yarn in an adhesive solution and heat-treating the yarn under such conditions, the dimensional stability of the tire cord can be further improved, and the change in physical properties can be further reduced during vulcanization of the tire.

Hereinafter, the present disclosure will be described in more detail with reference to Examples and Comparative Examples. However, the following Examples and Comparative Examples are only for facilitating the understanding of the present disclosure, and are not intended to limit the scope of the present disclosure.

### Examples and Comparative Examples: Production of Polyester Yarn

### Examples 1 to 3

A polyester yarn 6 made of polyethylene terephthalate (PET) having a monofilament single filament fineness of 2.7 to 3.4 denier (d) and a total fineness of 1500 denier (d) was produced by using the yarn production apparatus 1 shown in FIG. 1.

Specifically, PET chips including 90 mol % of PET and having an intrinsic viscosity (I.V.) of 1.0 to 1.4 dl/g were melted with a single screw extruder to produce a molten polyester resin. Then, as described in Table 1 below, the molten polyester resin was spun through a spinneret 170 (L/D=4.0/1.0, number of discharge holes: 500) at a spinning speed of 3200 m/min to produce a plurality of filaments 2.

At this time, the conditions for producing a plurality of filaments including the passage speed of the spinneret were adjusted as shown in Table 2 (DPF, Polymer discharge speed at nozzle, Shear rate at nozzle, Spinning pack pressure).

Then, the plurality of filaments 2 was heated through a heating unit, the plurality of filaments 2 were cooled in the cooling unit 30, and the cooled filaments 2 were bundled to produce an undrawn multifilament 4 (undrawn yarn).

The melt for spinning was extruded through a spinneret to obtain a polyester drawn yarn having a total fineness of 1000 denier (single fineness of about 4 denier). The process of obtaining the polyester drawn yarn was carried out under a spinning temperature of 290° C., a spinning speed of 3200 m/min, a total draw ratio of 1.5 times, and a relaxation rate of 1.5% (heat treatment at 180° C. after drawing).

The drawn multifilament was wound to produce a polyester yarn (drawn yarn).

### Comparative Examples 1 to 2, Reference Example 1

A polyester yarn was produced in the same manner as in Example 1, except that the spinneret diameter, hole number, spinning conditions and spinning pack pressure were changed as shown in Tables 1 and 2 below.

TABLE 1

| | | | | Comparative | Comparative | Reference |
|---|---|---|---|---|---|---|
| | Example 1 | Example 2 | Example 3 | Example 1 | Example 2 | Example 1 |
| Spinning speed | 3200 | 3200 | 3200 | 3200 | 2500 | 3100 |
| (mpm) | | | | | | |
| Final fineness | 1500 | 1500 | 1500 | 1500 | 1500 | 1500 |
| (De′) | | | | | | |
| Winding speed | 5620 | 6000 | 5620 | 6000 | 7000 | 5500 |
| (mpm) | | | | | | |
| Spinneret | 1 | 1 | 1 | 1 | 1 | 1 |
| Dia. (mm) | | | | | | |
| Hole number | 500 | 550 | 445 | 600 | 650 | 384 |
| Spinning draft | 1851 | 1908 | 1648 | 2081 | 1510 | 1408 |
| ′Total Max. | 3963 | 4083 | 3527 | 4455 | 4136 | 3110 |
| draft | | | | | | |

TABLE 2

| | | Polymer | | Spinning |
|---|---|---|---|---|
| | | discharge | Shear | pack |
| | | speed at | rate at | discharge |
| Condition | DPF | nozzle | nozzle | pressure |
| Unit | De/ea | m/min | 1/s | psi |
| Example 1 | 3.0 | 1.7 | 230 | 2200 |
| Example 2 | 2.7 | 1.7 | 224 | 1800 |
| Example 3 | 3.4 | 1.9 | 259 | 2500 |
| Comparative | 2.5 | 1.5 | 205 | 1600 |
| Example 1 | | | | |
| Comparative | 2.3 | 1.7 | 221 | 1400 |
| Example 2 | | | | |
| Reference | 3.9 | 2.2 | 294 | 2200 |
| Example 1 | | | | |

### Examples 4 to 6, Comparative Examples 3 to 4 and Reference Example 1: Production of Tire Cord

The tire cords of Examples 4 to 6, Comparative Examples 3 to 4, and Reference Example 2 were respectively produced using the polyester yarns produced in Examples 1 to 3, Comparative Examples 1 to 2 and Reference Example 1 under the same conditions.

Specifically, the polyester yarn was put into the cable cord twister, two strands of primarily twisted yarns (Z-direction) having a twist number of 460 TPM were prepared, and then the two strands of primarily twisted yarns were secondarily twisted (S-direction) together with a twist number of 460 TPM to produce a ply-twisted yarn (raw-cord). The ply-twisted yarn thus produced was immersed in an adhesive coating solution containing resorcinol-formaldehyde-latex (RFL), then dried at 150° C. for 100 seconds and heat-treated at 240° C. for 100 seconds to produce a tire cord (dip-cord). The tension applied to the raw-cord in the immersion, drying and heat treatment process was 0.5 kg/cord.

In addition, the total fineness of the raw-cord showed a denier of 1000 to 6000.

However, the tire cord of Comparative Example 6 using Comparative Example 3 could not be produced and thus its physical properties could not be measured.

### Experimental Example 1: Evaluation of Physical Properties of Polyester Yarn and Tire Cord

The tensile strength and elongation were measured for the polyester yarns produced in Examples, Comparative Examples, and Reference Examples, respectively, and tire cords using the same.

### Tensile Strength, Elongation at Break and Intermediate Elongation

In accordance with the ASTM D 885 standard test method, the tensile strength (g/d), elongation, and strength ratio according to Equation 2 of the drawn polyester yarn and tire cord were measured using a universal testing machine (Instron), and the results are shown in Tables 3 and 4 below. The specimen length was 250 mm, the tensile speed was 300 mm/min, and the initial load was set to 0.05 g/d.

In the stress-strain curve obtained by the above test, the elongation at a load of 4.5 g/d was indicated as ‘intermediate elongation’.

$$[ Equation 2 ]$$

$$Strength ratio ( \% ) = [ Tensile strength of tire cord ( g / d ) / Tensile strength of polyester yarn ( g / d ) ] \times 100$$

TABLE 3

| | | Intermediate | |
|---|---|---|---|
| | Tensile | elongation | |
| | strength | @4.5 kgf | Elongation |
| | (g/d) | (%) | (%) |
| Example 1 | 9.8 | 5.1 | 12.0 |
| Example 2 | 9.9 | 5.0 | 11.8 |
| Example 3 | 9.7 | 5.3 | 12.4 |
| Comparative | 10.1 | 4.7 | 10.6 |
| Example 1 | | | |
| Comparative | — | — | — |
| Example 2 | | | |
| Reference | 9.4 | 5.6 | 13.1 |
| Example 1 | | | |

TABLE 4

| | | Intermediate | | |
|---|---|---|---|---|
| | Tensile | elongation | | Strength |
| | strength | @4.5 kgf | Elongation | ratio |
| | (g/d) | (%) | (%) | (%) |
| Example 4 | 8.8 | 2.8 | 18.0 | 90 |
| Example 5 | 8.9 | 2.7 | 17.6 | 90 |
| Example 6 | 8.7 | 2.9 | 18.4 | 90 |
| Comparative | 9.1 | 2.7 | 16.2 | 90 |
| Example 3 | | | | |
| Comparative | — | — | — | 90 |
| Example 4 | | | | |
| Reference | 8.5 | 3.5 | 17.1 | 90 |
| Example 2 | | | | |

Referring to Tables 3 and 4, the polyester yarns of Examples 1 to 4 and the tire cords of Examples 4 to 6 using the same all exhibited excellent physical properties equal to or higher than the same level as compared with Comparative Examples and Reference Example.

### Experimental Example 2: Evaluation of Physical Properties of Tire Cords

The tenacity, modulus, toughness, and SWI physical properties were measured for the tire cords prepared in Examples, Comparative Examples, and Reference Examples, respectively. The results are shown in Table 5 below.

### (1) Tenacity and Toughness

In accordance with the ASTM D 885 standard test method, the tenacity, tensile strength (g/d), elongation (%) and toughness of the tire cord were measured using a universal testing machine (Instron). The specimen length was 250 mm (cord length: 600 mm), the tensile rate was 300 mm/min, and the initial load was set to 0.05 g/d.

### (2) Modulus (Lase@2%, LASE@5%)

In accordance with the ASTM D 885 standard test method, a stress-strain curve for each tire cord were obtained. Using this stress-strain curve, loads were obtained when length strains were 2% and 5%, respectively, and Lase@2%, LASE@5% were measured during elongation.

The sample before measurement was measured after leaving it for 24 hours in an atmosphere of 20° C. and 65% RH.

### (3) Side Wall Indentation (SWI)

SWI was measured according to the following Equation 1 using the equipment of Testrite, UK.

$$SWI ( \% ) = [ ( D ) - ( C ) ] + [ ( A ) - ( B ) ] \qquad [ Equation 1 ]$$

in Equation 1,
(A) is a dry heat shrinkage, measured after measuring the dry heat shrinkage using a shrinkage tester (measuring with a specimen length of 250 mm, 180° C., 2 minutes, under a load of an initial tension of 20 to 45 g), and then air-cooling it for 1 min,
(B) is a dry heat shrinkage, measured after measuring the dry heat shrinkage using a shrinkage tester (measuring with a specimen length of 250 mm, 180° C., 2 minutes, under a load of an initial tension of 40 to 90 g), and then air-cooling it for 1 min,
(C) is an intermediate elongation of the (A) specimen according to the ASTM D 885 standard test method measured at a load of 1.5 to 3.0 kg, and
(D) is an intermediate elongation of the (B) specimen according to the ASTM D 885 standard test method measured at a load of 3.0 to 6.0 kg.

Further, the (A) may be 1.0 to 3.2%, the (B) may be 0.7 to 2.8%, the (C) may be 1.3 to 1.7%, and the (D) may be 4.2 to 4.6%.

Specifically, the specimen 2500 mm having a total fineness of 1000 to 6000 denier was left at 25° C., 65% RH for 24 hours, and then the length (L₀) measured under an initial tension load of 0.01 g/d was measured. Then, the specimen was treated under an initial tension load of 0.01 g at 180° C. for 2 minutes using the shrinkage tester, and then the length (L₁) of the specimen was measured. The L₀ and L₁ were measured three times each. The length change rate {=[(L₀−L₁)/L₀]×100} of the specimen was defined as the dry heat shrinkage rate (L₂) before cooling down.

Further, the dry heat shrinkage of the specimen was measured using the shrinkage tester, then the specimen was taken out of the tester under the same load, and left at room temperature (25° C.) for about 1 minute, and then the dry heat shrinkage was measured in a state where the cord was stable. That, the dry heat shrinkage after cooling down represents the length change rate of L₂ and L₃ ({=[(L₂−L₃)/L₂]×100}) after measuring the length (L₃) of the specimen that has been left to cool down for 1 minute after the measurement of L₂.

TABLE 5

| Physical | | LASE | LASE | | |
|---|---|---|---|---|---|
| properties | Tenacity | @2% | @5% | Toughness | SWI |
| Unit | g/d | g/d | g/d | g/ · mm | % |
| Example 4 | 8.8 | 1.3 | 2.3 | 194.0 | 3.4 |
| Example 5 | 8.9 | 1.4 | 2.4 | 196.7 | 3.3 |
| Example 6 | 8.7 | 1.2 | 2.2 | 191.7 | 3.5 |
| Comparative | 9.1 | 1.4 | 2.7 | 181.7 | 3.7 |
| Example 3 | | | | | |
| Comparative | — | — | — | — | — |
| Example 4 | | | | | |
| Reference | 8.5 | 1.0 | 2.3 | 175.0 | 3.5 |
| Example 2 | | | | | |

Referring to Table 5, the tire cords of Examples 4 to 6 have a tenacity of 8.0 g/d or more, a LASE@2% of 1.1 g/d or more, and a LASE@5% of 2.5 g/d or less, and a toughness of 183 g/d·mm or more according to the ASTM D 885 standard test method, and satisfy a SWI value of 3.6% or less. That is, Examples 4 to 6 exhibit high modulus, low shrinkage and high elongation effects, while the tire cord maintains excellent strength even after the yarn post-treatment process, showing superior results to Comparative Examples 3 to 4 and Reference Example 2.

On the other hand, Comparative Example 3 exhibited a certain strength, but had lower modulus and toughness than those of Examples, and exhibited SWI of 3.7%, showing poor result as a whole.

In addition, in Comparative Example 4, it was impossible to manufacture a tire cord.

Further, in Reference Example 2 has a spinning draft lower than the range of the present disclosure, the DPF was as high as 3.9, and the toughness value was as low as 175.0 g/d·mm. Further, in Reference Example 2, the LASE@2% value was 1.0%, which was lower than that of Examples, thereby limiting the improvement of the modulus.

### (4) Strip Strength

For the tire cord of Example 6, the strip strength was measured according to Table 6 below, based on 1500 De (warp density: 118 ea/decimeter, load: 26.1 Kg).

Specifically, the cord in the tire may have a warp density of 118 ea/decimeter when the cord has the tenacity of 8.0 g/d or more based on 1500 denier. Therefore, strip strength can be calculated using the density values of the tire cords.

At this time, the strip strength was also measured when the tire cord strength was 8.0 g/d.

TABLE 6

| | | | In CASE OF | |
|---|---|---|---|---|
| | | (Example 6) | CORD STRENGTH | |
| | | 1500 De × 2 | 8.0 g/d | |
| | | (Tenacity 8.7 g/d) | (Tenacity) | Note |
| Strip | Kg/dm | 26.1 × 118 = 3079.8 | 24 × 118 = 2832 | Cord |
| Strength | | | | Strength(Kg) × |
| | | | | EPDM |
| | Kg/dm/denier | 3079.8/3000 = 1.0266 | 2832/3000 = 0.944 | Strip Strength/ |
| | | | | Denier |

As shown in Table 6, in Example 6 (tenacity 8.7 g/d) and the tire cord having a strength of 8.0 g/d, as the strip strength of the tire cord satisfies 0.94 Kg/dm/denier or more, the fabric in the tire cord exhibits excellent strength, thereby providing a high-strength tire.

Therefore, when manufacturing yarn for providing tire cords, it is necessary to adjust the pressure of the spinning pack while applying the high multi filament spinning method with specified spinning conditions, so that all physical properties are excellent and especially the toughness can be maintained high.

Although preferred embodiments of the present disclosure have been described above, the present disclosure is not limited thereto. The embodiments of the present disclosure include all modifications within the range of being easily modified by a person having ordinary knowledge in the technical field to which the present disclosure belongs and recognized as being equivalent.

### DESCRIPTION OF REFERENCE NUMBERS

1: Polyester yarn production apparatus
2: Filament
4: Non-stretched multifilament
6: Polyester yarn
10: Extruders
12: Hopper
20: Spinning Package
30: Cooling unit
32: Cooling chamber
34: Coolant inlet
36: First coolant outlet
40: Bundling unit
50: Stretching unit
52, 54,56,58: Galette roller
60: Winder

1. A tire cord, comprising a polyester yarn including 90 mol % or more of polyethylene terephthalate, and having a tenacity of 8.0 g/d or more, a LASE@2% of 1.1 g/d or more, and a LASE@5% of 2.5 g/d or less, and a toughness of 183 g/d·mm or more according to the ASTM D 885 standard test method, and satisfying a side wall indentation (SWI) value of 3.6% or less.

2. The tire cord according to claim 1, wherein:
the side wall indentation is measured by the following Equation 1:
$$SWI ( \% ) = [ ( D ) - ( C ) ] + [ ( A ) - ( B ) ] \qquad [ Equation 1 ]$$
in Equation 1,
(A) is a dry heat shrinkage, measured after measuring the dry heat shrinkage using a shrinkage tester (measuring with a specimen length of 250 mm, 180° C., 2 minutes, under a load of an initial tension of 20 to 45 g), and then air-cooling it for 1 min,
(B) is a dry heat shrinkage, measured after measuring the dry heat shrinkage using a shrinkage tester (measuring with a specimen length of 250 mm, 180° C., 2 minutes, under a load of an initial tension of 40 to 90 g), and then air-cooling it for 1 min,
(C) is an intermediate elongation of the (A) specimen according to the ASTM D 885 standard test method measured at a load of 1.5 to 3.0 kg, and
(D) is an intermediate elongation of the (B) specimen according to the ASTM D 885 standard test method measured at a load of 3.0 to 6.0 kg.

3. The tire cord according to claim 2, wherein:
the (A) is 1.0 to 3.2%, the (B) is 0.7 to 2.8%, the (C) is 1.3 to 1.7%, and the (D) is 4.2 to 4.6%.

4. The tire cord according to claim 1, wherein:
the tire cord has a strip strength of 0.94 kg/dm/denier or more.

5. The tire cord according to claim 1, wherein:
the tire cord has a strength utilization ratio of 88% or more according to the following Equation 2.
$$[ Equation 2 ]$$
$$Strength utilization ratio ( \% ) = [ Tensile strength of tire cord ( g / d ) / Tensile strength of polyester raw yarn ( g / d ) ] \times 100$$

6. The tire cord according to claim 1, wherein:
the tire cord comprises a high-tenacity polyester yarn made from polyester multifilament including 200 to 2,000 polyester monofilaments having a fineness of 2.5 to 3.5 denier; and
an adhesive layer impregnated with the high-tenacity polyester raw yarn.

7. The tire cord according to claim 6, wherein:
the polyester yarn is made from a molten polyester resin comprising 90 mol % or more of polyethylene terephthalate and having an intrinsic viscosity of 1.0 dl/g or more.

8. The tire cord according to claim 6, wherein:
the polyester yarn has a tensile strength of 7.5 to 11.0 g/d and an elongation of 10 to 20%.

9. The tire cord according to claim 1, wherein:
the tire cord comprises a raw-cord having a total fineness of 1,000 to 9,000 denier.

10. A method for manufacturing a tire cord of claim 1, comprising the steps of:
spinning a molten polyester resin comprising 90 mol % or more of polyethylene terephthalate and having an intrinsic viscosity of 1.0 dl/g or more using a spinning pack including a spinneret having a nozzle unit to produce a polyester yarn;
producing a ply-twisted yarn using the polyester yarn; and
immersing the ply-twisted yarn in an adhesive solution and heat-treating the yarn,
wherein the step of producing the polyester yarn comprises,
discharging the molten polyester resin through a spinneret including a nozzle unit having a shear rate of 220 to 260 1/sec and a polymer discharge rate of 2.0 m/min or less under the pressure condition of the spinning pack of 1800~2500 psi to form a polyester multifilament including a polyester monofilament having a fineness of 2.5 to 3.5 denier.

11. The method for manufacturing a tire cord according to claim 10, wherein:
the polyester multifilament comprises 200 to 2,000 polyester monofilaments having a fineness of 2.5 to 3.5 denier.

12. The method for manufacturing a tire cord according to claim 10, wherein:
the step of producing a polyester yarn comprises,
discharging the molten polyester resin with an intrinsic viscosity of 1.0 dl/g or more through a spinneret including a nozzle unit having a shear rate of 220 to 260 1/sec and a polymer discharge rate of 2.0 m/min or less under the pressure condition of the spinning pack of 1800~2500 psi to produce a plurality of filaments;
heating the plurality of discharged filaments through a heating unit;
cooling the plurality of heated filaments through a cooling unit;
bundling the plurality of filaments to form a polyester multifilament;
drawing the polyester multifilament; and
winding the drawn multifilament.

13. The method for manufacturing a tire cord according to claim 12, wherein:
the step of drawing the polyester multifilament comprises drawing the polyester multifilament in a total draw ratio of 1.0 to 3.0 times.
